(19) United States
(12) Patent Application Publication
(10) Pub. No.: US 2004/0041294 A1
(43) Pub. Date: Mar. 4, 2004

(54) Fuel cell separator manufacturing method and fuel cell separator

(76) Inventors: Ayumi Horiuchi, Okazaki-shi (JP); Takenori Ikeda, Okazaki-shi (JP); Kazuo Saito, Okazaki-shi (JP)

Correspondence Address: BIRCH STEWART KOLASCH & BIRCH, PO BOX 747, FALLS CHURCH, VA, 22040-0747, US

(21) Appl. No.: 10/636,608

(22) Filed: Aug. 8, 2003

(30) Foreign Application Priority Data
Aug. 9, 2002 (JP) 2002-233800

(51) Int. Cl. B29C 65/00

(52) U.S. Cl. 264/109; 264/41; 429/129

(57) ABSTRACT

A fuel cell separator is manufactured by charging a powdered molding material into a mold and compression molding the powdered material at a pressure of 0.98 to 49 MPa. The powdered material is charged in varying amounts for respective predetermined regions of the fuel cell separator. This process enables the inexpensive mass production of even fuel cell separators having a complex channel geometry to a uniform density, uniform pore characteristics and a good precision.

### BACKGROUND OF THE INVENTION

1. Field of the Invention

The present invention relates to a method of manufacturing fuel cell separators. The invention also relates to fuel cell separators obtained by this method.

2. Prior Art

Fuel cells are devices which, when supplied with a fuel such as hydrogen and with atmospheric oxygen, cause the fuel and oxygen to react electrochemically, producing water and directly generating electricity. Because fuel cells are capable of achieving a high fuel-to-energy conversion efficiency and are environmentally friendly, they are being developed for a variety of applications, including small-scale local power generation, household power generation, simple power supplies for isolated facilities such as campgrounds, mobile power supplies such as for automobiles and small boats, and power supplies for satellites and space development.

Such fuel cells, and particularly solid polymer fuel cells, are built in the form of modules composed of a stack of at least several tens of unit cells. Each unit cell has a pair of plate-like separators with raised and recessed areas on either side thereof that define a plurality of channels for the flow of gases such as hydrogen and oxygen. Disposed between the pair of separators in the unit cell are a solid polymer electrolyte membrane and gas diffusing electrodes made of carbon paper.

The role of the fuel cell separators is to confer each unit cell with electrical conductivity, to provide flow channels for the supply of fuel and air (oxygen) to the unit cells, and to serve as a separating or boundary membrane between adjacent unit cells. Qualities required of the separators include high electrical conductivity, high gas impermeability, electrochemical stability and hydrophilic properties.

These fuel cell separators are produced in a number of different ways. One prior-art process involves the use of a machining operation to cut out channels in porous fired carbon. In another process, described in U.S. Pat. No. 6,187,466, a slurry prepared from graphite powder, binder resin and cellulose fibers is formed into a sheet by a papermaking process, following which the sheet is graphitized.

In the first of these processes, the fact that the channels are formed by a machining operation makes this approach labor intensive and thus more costly, and also results in a lower yield. Moreover, cutting is poorly suited to the production of fuel cell separators having a complex channel geometry.

The latter process requires a graphitizing step, which increases the complexity of the production operations and raises production costs. Hence, this approach is not cost-effective.

### SUMMARY OF THE INVENTION

It is therefore one object of the invention to provide a method capable of inexpensively mass-producing fuel cell separators which, even when having a complex channel geometry, can easily be conferred with a uniform density and uniform pores. Another object of the invention is to provide fuel cell separators obtained by this method.

We have discovered that, in a fuel cell separator manufacturing process that involves charging a powdered molding material into a compression mold and compression molding the powdered material, by varying the amount of powdered material charged for respective predetermined regions of the separator to be molded, and particularly for regions that correspond to the raised and recessed features of channels in the separator, a uniform density and uniform pores can easily be achieved even in separators having a complex channel geometry.

Accordingly, in one aspect, the invention provides a method of manufacturing fuel cell separators which includes the steps of charging a powdered molding material into a compression mold, and compression molding the powdered material at a pressure of 0.98 to 49 MPa; wherein the powdered material is charged in varying amounts for respective predetermined regions of the fuel cell separator.

In another aspect, the invention provides a method of manufacturing fuel cell separators which includes the steps of inserting a prefabricated preform into a compression mold, charging a powdered molding material onto the inserted preform, and compression molding the preform and the powdered material at a pressure of 0.98 to 49 MPa; wherein the powdered material is charged in varying amounts for respective predetermined regions of the fuel cell separator.

In either above fuel cell manufacturing method of the invention, the predetermined regions are preferably areas of differing volume on the fuel cell separator. It is advantageous for the fuel cell separator to have recessed areas and raised areas, and for the predetermined regions to be these recessed areas and raised areas.

In the above aspects of the invention, the fuel cell separator generally has a density variation of less than 5% and may be porous. If the separator is porous, the porosity is preferably from 1 to 50% and the pressure applied when compression molding the separator is preferably from 0.98 to 14.7 MPa.

The invention additionally provides a fuel cell separator obtained by either of the foregoing manufacturing methods.

### BRIEF DESCRIPTION OF THE DIAGRAMS

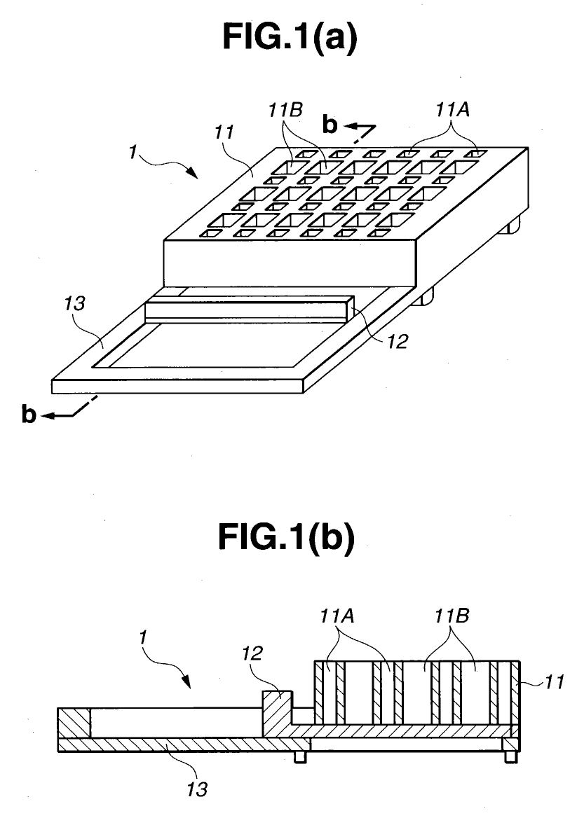

FIG. 1 illustrates a powdered material charging device such as may be used according to one embodiment of the invention. FIG. 1a is a perspective view of the device, and FIG. 1b is a sectional view taken along line b-b in FIG. 1a.

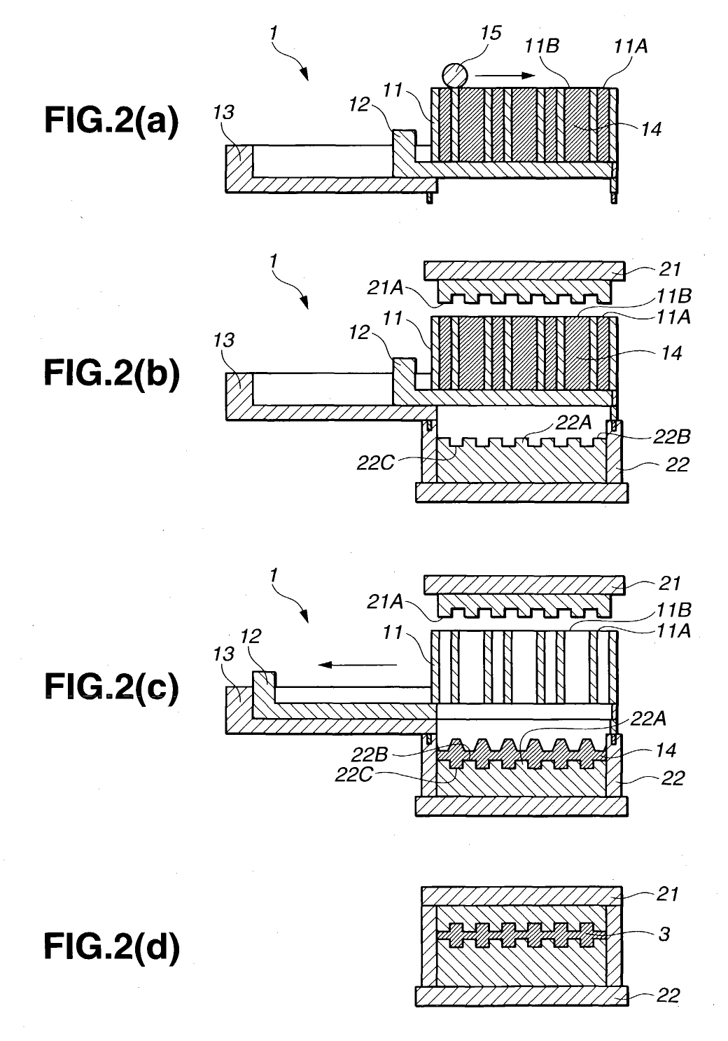

FIG. 2 shows schematic sectional views of individual steps, from charging of the powdered material to compression molding, according to the same embodiment of the invention.

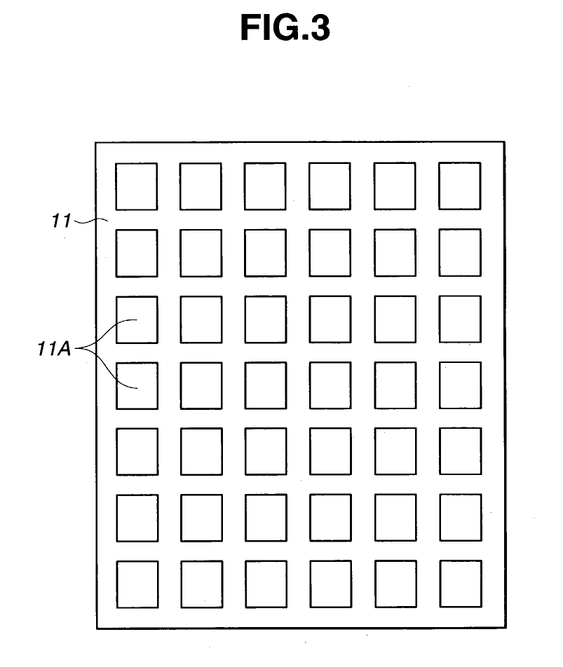

FIG. 3 is a top view showing the charging member of a charging device such as may be used in another embodiment of the invention.

### DETAILED DESCRIPTION OF THE INVENTION

The objects, features and advantages of the invention will become more apparent from the following detailed description, taken in conjunction with the foregoing diagrams.

As noted above, the fuel cell separator manufacturing method of the invention involves charging a powdered molding material into a compression mold and compression molding the powdered material at a pressure of 0.98 to 49 MPa. The powdered material is charged in amounts that vary for respective predetermined regions of the fuel cell separator. In another version of the inventive method, first a prefabricated preform is inserted into the compression mold, after which the powdered molding material is charged onto the preform and both the insert and the powdered material are compression molded.

The powdered molding material used in the method of the invention may be any powdered molding material commonly employed in the production of fuel cell separators, including materials prepared by subjecting a mixture of electrically conductive powder and resin to a compounding operation.

The electrically conductive powder is not subject to any particular limitation. Illustrative examples include natural graphite, synthetic graphite and expanded graphite. The conductive powder has an average particle size in a range of preferably about 10 to 100 μm, and most preferably 20 to 60 μm.

The resin may be suitably selected from among thermoset resins, thermoplastic resins and other resins commonly used in fuel cell separators. Specific examples of resins that may be used include phenolic resins, epoxy resins, acrylic resins, melamine resins, polyamide resins, polyamideimide resins, polyetherimide resins and phenoxy resins. If necessary, these resins may be heat treated.

No limitation is imposed on the proportions in which the conductive powder and the resin are blended, although it is desirable for the powdered molding material to include, per 100 parts thereof: 50 to 99 parts by weight, and especially 65 to 90 parts by weight, of the conductive powder; and 1 to 50 parts by weight, and especially 5 to 20 parts by weight, of the resin.

In the practice of the invention, these blended components are typically used after being subjected to a compounding operation carried out by any suitable method. Blended components that have been stirred, granulated and dried by known methods may be used, although it is preferable to use as the powdered molding material a blend which has been screened to prevent secondary agglomeration and adjusted to a specific particle size. The powdered molding material has an average particle size which varies with the particle size of the conductive powder used, but is preferably at least 60 μm. The particle size distribution is preferably from 10 μm to 2.0 mm, more preferably from 30 μm to 1.5 mm, and most preferably from 50 μm to 1.0 mm.

If necessary, the powdered molding material may include also an inorganic filler such as carbon fibers, other carbonaceous materials or activated alumina in an amount of 0.1 to 20 parts by weight, and preferably 1 to 10 parts by weight, per 100 parts by weight of the overall powdered material.

The pressure applied during compression molding may be selected as appropriate for the density and other properties of the separator being manufactured, but is generally from 0.98 to 49 MPa, preferably from 0.98 to 14.7 MPa, and most preferably from 1.96 to 9.8 MPa. At a molding pressure of less than 0.98 MPa, a strength sufficient to maintain the shape of the fuel cell separator may not be achieved. On the other hand, at a pressure greater than 49 MPa, strain may arise in the molding machine and mold, lowering the planar and dimensional precision of the resulting fuel cell separator.

The predetermined regions of the fuel cell separator where the powdered material is charged in varying amounts are not subject to any particular limitation and may be, for example, areas of the fuel cell separator that are required to be particularly strong, areas of differing volume, or recessed and raised areas corresponding to the channel geometry.

It is especially preferable for these predetermined regions to be areas of differing volume on the fuel cell separator.

“Areas of differing volume,” as used herein, refers to areas of differing compressibility during molding. That is, the fuel cell separator is manufactured by charging large relative amounts of the powdered material for large volume areas (areas of low compressibility) of the separator and charging small relative amounts of the powdered material for small volume areas (areas of high compressibility).

It is even more preferable for the areas of differing volume at this time to be recessed areas (channels) and raised areas (ribs) formed on the fuel cell separator. In such a case, small relative amounts of powdered material are charged for those predetermined regions that are recessed areas, and large relative amounts of powdered material are charged for those predetermined regions that are raised areas.

By varying in this way the amounts of powdered material charged for recessed areas and raised areas of the separator, density differences between the recessed areas of high compressibility and the raised areas of low compressibility can easily be prevented, facilitating the production of fuel cell separators of uniform density and uniform pore size.

In the practice of the invention, the method used to charge the powdered molding material into the compression mold involves varying the amount of powdered material charged for respective predetermined regions according to the shape of the fuel cell separator. It is thus advantageous to employ a charging device 1 like that shown in FIG. 1, although use may be made of any device or means which is capable of varying the amount of powdered molding material charged for respective predetermined regions.

Referring to FIG. 1, the powdered material charging device 1 has a charging member 11, a slide plate 12 situated below the charging member 11, and a base 13 which is integrally molded with the charging member 11 and is formed as a border that encloses the slide plate 12.

The charging member 11 has formed therein first charging holes 11A and second charging holes 11B which are each of substantially rectangular shape and are arranged in alternating rows.

The respective charging holes 11A and 11B pass vertically through the charging member 11 and are each open at the bottom thereof.

The first charging holes 11A have a smaller bore than the second charging holes 11B, the difference in the bores being used to vary the amount of powdered material charged into the compression mold. The respective bores of charging holes 11A and 11B can be selected as appropriate for the separator to be manufactured. The arrangement of the holes 11A and 11B can be selected in accordance with the intended shape of the separator.

It has already been noted above that the base 13 is integrally molded with the charging member 11. In addition, as shown in FIG. 1b, the portion of the base 13 over which the charging holes 11A and 11B are situated is hollow.

The base 13 and the charging member 11 have formed therebetween a gap of a given size, within which the slide plate 12 is disposed so as to be freely slideable.

The slide plate 12 is designed so as to be freely movable from a condition in which the bottoms of the charging holes 11A and 11B are closed to a condition in which they are open.

Charging of the powdered molding material into a compression mold using a charging device 1 of the foregoing construction and compression molding may be carried out as follows.

As shown in FIG. 2a, a powdered molding material 14 is charged into each of the charging holes 11A and 11B in the charging member 11, then is leveled off with a leveling rod 15, thereby filling the respective holes 11A and 11B with predetermined amounts of the molding material 14.

Next, as shown in FIG. 2b, the charging device 1 filled with the powdered molding material 14 is set on the bottom half 22 of a compression mold in a press having a top mold half 21 and bottom mold half 22. The bottom half 22 bears a pattern 22A for forming gas flow channels on one side of the fuel cell separator, and the top half 21 bears a pattern 21A for forming gas flow channels on the other side of the separator.

In this particular case, the first charging holes 11A of small bore are situated above raised areas 22B (areas which correspond to recessed areas of the separator) of the pattern 22A on the bottom mold half 22, and the second charging holes 11B of large bore are situated above recessed areas 22C (areas which correspond to raised areas of the separator) of the same pattern 22A.

In cases where a preform is used, a preform molded into a shape which conforms with the shape of the pattern 22A on the bottom half 22 of the mold is placed on the bottom half 22.

After the charging device 1 has been set on the bottom half 22, as shown in FIG. 2c, the slide plate 12 is moved toward the left side in the diagram so as to open the bottoms of the respective charging holes 11A and 11B, allowing the powdered molding material 14 filled into these holes to fall onto the pattern 22A on the bottom half 22 of the mold. As a result, a small amount of the powdered material 14 is charged onto raised areas 22B of the pattern 22A and a large amount of the powdered material 14 is charged onto recessed areas 22C.

As shown in FIG. 2d, by clamping the mold shut in this state with the top half 21 thereof and compression molding at a mold temperature of, say, 100 to 250° C., and preferably 140 to 200° C., and a molding pressure of 0.98 to 49 MPa, there can be obtained a fuel cell separator 3.

With this type of charging device 1, the amount of powdered molding material charged into areas of the mold which correspond to the recessed and raised areas of channels in the fuel cell separator can easily be varied, enabling a uniform density and uniform pores to be achieved in the resulting fuel cell separator.

Alternatively, use can be made of a charging member 11 like that shown in FIG. 3 having charging holes 11A which are all of the same bore, in which case the powdered molding material may be charged a plurality of times in areas where a large charging amount is required.

If a preform is used, the preform may be molded by any suitable method. For example, the powdered molding material may be charged into a preform mold using the above-described charging device, and molded at a mold temperature of 0 to 120° C., preferably 30 to 100° C., and a molding pressure of 0.098 to 9.8 MPa. The resulting preform can then be cut so as to conform with the shape of the compression mold used to manufacture the fuel cell separator.

No particular limitation is imposed on the shape of the preform used in such a case, although it is preferable for the preform to have the same channel geometry as the fuel cell separator to be manufactured.

It is desirable for fuel cell separators manufactured as described above to have a density variation of less than 5%, preferably less than 3%, and most preferably less than 2%. “Density variation,” as used herein, refers to the variation in density, as computed from weight and volume measurements, at respective predetermined regions of the fuel cell separator.

At a density variation of 5% or more, the fuel cell separator may undergo local decreases in strength and may exhibit variations in electrical resistance and heat conductivity.

In cases where the fuel cell separators produced by the method of the invention are porous, it is advantageous for the pores to have a diameter of 0.01 to 50 μm, and preferably 0.1 to 10 μm, and for the porosity to be 1 to 50%, preferably 5 to 50%, and most preferably 10 to 30%.

At a pore diameter smaller than 0.01 μm, water produced during power generation by the fuel cell passes through the separator with greater difficulty and may obstruct the gas flow channels. On the other hand, at a pore diameter larger than 50 μm, precise formation of the channel geometry may not be possible.

At a porosity of less than 1%, the ability to absorb water that forms during power generation decreases, which may result in obstruction of the gas flow channels. On the other hand, at a porosity of more than 50%, precise formation of the channel shapes may be impossible.

When a porous fuel cell separator is produced by the inventive method, the molding pressure is preferably from 0.98 to 14.7 MPa. At less than 0.98 MPa, the strength of the resulting separator may decline. On the other hand, at a pressure greater than 14.7 MPa, the pores may become filled, increasing the possibility that a porous separator cannot be achieved.

Fuel cell separators obtained by the manufacturing method of the invention are highly suitable for use as separators in solid polymer fuel cells.

As described above, the present invention enables the inexpensive mass production of fuel cell separators having either a dense or porous construction of uniform density and uniform pores by a simple and expedient method. Moreover, because the method of the invention is capable of molding flow channel-bearing plates, it eliminates the need for machining operations and requires no firing step, thus making it possible to reduce production costs.

In addition, low-pressure molding is possible. As a result, good planar and dimensional precision can readily be achieved, in addition to which the formation of flash on the resulting fuel cell separators can be minimized, making it possible to reduce material waste.

### EXAMPLES

The following examples and comparative examples are provided to illustrate the invention and are not intended to limit the scope thereof. Average particle sizes given below were measured using a Microtrak particle size analyzer.

### Example 1

A composition of 90 parts by weight of artificial graphite powder having an average particle size of 90 μm and 10 parts by weight of phenolic resin was granulated and dried, then screened, yielding a powdered molding material having a particle size adjusted to 0.5 mm or less.

This powdered molding material was charged into the respective charging holes 11A and 11B of the charging device 1 shown in FIGS. 1 and 2, and leveled off at the top of the holes with a leveling rod 15 to fill each hole. Next, the slide plate 12 was slid so as to open the bottom of the respective charging holes 11A and 11B, thereby charging differing amounts of the powdered molding material 14 onto the recessed areas and raised areas of a pattern 22A on the bottom half 22 of a compression mold.

In this example, the first charging holes 11A had a cross-sectional size of 15×15 mm, the second charging holes 11B had a cross-sectional size of 25×25 mm, and the number of first charging holes 11A and second charging holes 11B was 18 each.

Next, the top half 21 of the mold was clamped shut over the bottom half 22 and compression molding was carried out at 170° C. and 10 MPa to form a fuel cell separator.

### Example 2

Aside from using artificial graphite powder having an average particle size of 60 μm, a fuel cell separator was obtained in the same way as in Example 1.

### Example 3

Aside from preparing a powdered molding material having a particle size of 0.5 to 1.0 mm from 86 parts by weight of an artificial graphite powder having an average particle size of 20 μm and 14 parts by weight of phenolic resin, a fuel cell separator was obtained in the same way as in Example 1.

### Example 4

Aside from preparing a powdered molding material from 80 parts by weight of an artificial graphite powder having an average particle size of 60 μm, 10 parts by weight of phenolic resin and 10 parts by weight of carbon fibers, a fuel cell separator was obtained in the same way as in Example 1.

### Example 5

Aside from preparing a powdered molding material from 80 parts by weight of an artificial graphite powder having an average particle size of 60 μm, 10 parts by weight of phenolic resin and 10 parts by weight of activated carbon, a fuel cell separator was obtained in the same way as in Example 1.

### Example 6

Aside from preparing a powdered molding material from 80 parts by weight of an artificial graphite powder having an average particle size of 60 μm, 10 parts by weight of phenolic resin and 10 parts by weight of activated alumina, a fuel cell separator was obtained in the same way as in Example 1.

### Example 7

Aside from changing the amount of artificial carbon powder to 70 parts by weight and the amount of phenolic resin to 30 parts by weight, a fuel cell separator was obtained in the same way as in Example 1.

### Example 8

Aside from preparing a powdered molding material from 65 parts by weight of an artificial graphite powder having an average particle size of 60 μm and 35 parts by weight of phenolic resin, a fuel cell separator was obtained in the same way as in Example 1.

### Example 9

Aside from preparing a powdered molding material having a particle size of 0.5 to 1.0 mm from 60 parts by weight of an artificial graphite powder having an average particle size of 20 μm and 40 parts by weight of phenolic resin, a fuel cell separator was obtained in the same way as in Example 1.

### Comparative Example 1

Aside from preparing a powdered molding material having a particle size of 0.5 to 1.0 mm from 86 parts by weight of an artificial graphite powder having an average particle size of 20 μm and 14 parts by weight of phenolic resin, and setting the molding pressure to 100 MPa, a fuel cell separator was obtained in the same way as in Example 1.

### Comparative Example 2

Aside from preparing a powdered molding material having a particle size of 0.5 to 1.0 mm from 86 parts by weight of an artificial graphite powder having an average particle size of 20 μm and 14 parts by weight of phenolic resin, and setting the molding pressure to 0.49 MPa, a fuel cell separator was obtained in the same way as in Example 1.

### Comparative Example 3

Aside from preparing a powdered molding material having a particle size of 0.5 to 1.0 mm from 86 parts by weight of an artificial graphite powder having an average particle size of 20 μm and 14 parts by weight of phenolic resin, and charging the powdered molding material uniformly onto the bottom half 22 of the mold, a fuel cell separator was obtained in the same way as in Example 1.

### Comparative Example 4

Aside from mixing 86 parts by weight of artificial graphite powder having an average particle size of 20 μm with 14 parts by weight of phenolic resin and using the resulting composition directly without compounding (that is, without preparation as a powdered molding material), a fuel cell separator was obtained in the same way as in Example 1.

The fuel cell separators obtained in each of the above examples and comparative examples were evaluated to determine the state (whether of a porous or dense construction) and uniformity of the molded article, and subjected to measurements of density, variation in density, porosity, gas permeability, flexural strength, flexural modulus and specific resistance. The following methods were used. The results are given in Table 1.

1. State and Uniformity of Molded Article

These qualities were evaluated by visually examining the molded separators. The uniformity was rated as “good” or “poor.”

2. Density

The density was calculated from the measured weight and volume of the fuel cell separator.

3. Density Variation

Five areas on a separator were selected at random and cut out, and the density of each was determined. The variation in density was calculated as the difference between the maximum density and minimum density obtained.

4. Porosity

Measured by mercury injection porosimetry.

5. Gas Permeability

Measured in general accordance with the “Equal Pressure Method” described in JIS K-7126.

6. Flexural Strength, Flexural Modulus

Measured in general accordance with the method described in ASTM D790.

7. Specific Resistance

Measured by the four-probe method described in JIS H-0602.

TABLE 1

| | | | | | | Gas | | | |
|---|---|---|---|---|---|---|---|---|---|
| | State of | | | Density | | permeability | Flexural | Flexural | Specific |
| | molded | | Density | variation | Porosity | (cc · cm/ | strength | modulus | resistance |
| | article | Uniformity | (g/cm³) | (%) | (%) | (cm² · s · cmHg)) | (MPa) | (GPa) | (mΩ · cm) |
| Example 1 | porous | good | 1.3 | 1 | 18 | 1 × 10⁻³ | 21 | 12 | 5 |
| Example 2 | porous | good | 1.3 | 1 | 22 | 1 × 10⁻³ | 25 | 13 | 4 |
| Example 3 | porous | good | 1.3 | 1 | 20 | 1 × 10⁻³ | 23 | 5.9 | 12 |
| Example 4 | porous | good | 1.4 | 1 | 15 | 1 × 10⁻³ | 31 | 17 | 10 |
| Example 5 | porous | good | 1.2 | 1 | 25 | 1 × 10⁻³ | 19 | 6 | 20 |
| Example 6 | porous | good | 1.3 | 1 | 24 | 1 × 10⁻³ | 18 | 12 | 8 |
| Example 7 | dense | good | 1.9 | 1 | 0 | 1 × 10⁻⁶ | 45 | 15 | 15 |
| Example 8 | dense | good | 1.8 | 1 | 0 | 1 × 10⁻⁶ | 50 | 14 | 17 |
| Example 9 | dense | good | 1.8 | 1 | 0 | 8 × 10⁻⁵ | 55 | 16 | 25 |
| Comparative | dense | good | 1.7 | 8 | 0 | 5 × 10⁻⁵ | 36 | 12 | 6 |
| Example 1 | | | | | | | | | |
| Comparative | molding | poor | 1.1 | 70 | 50 | not | 5 | 1 | 100 |
| Example 2 | impossible | | | | | measured | | | |
| Comparative | non- | poor | 1.3 | 10 | 2 | 1 × 10⁻³ | 14 | 7 | 12 |
| Example 3 | uniform | | | | | | | | |
| Comparative | non- | poor | 1.3 | 20 | 40 | 5 × 10⁻² | 12 | 3 | 30 |
| Example 4 | uniform | | | | | | | | |

The results in Table 1 show that the fuel cell separators obtained in each of the examples according to the invention, whether of porous construction or dense construction, had an excellent uniformity with less variation in density than the fuel cell separators obtained in the comparative examples

As described and demonstrated above, by charging the powdered molding material in varying amounts for predetermined regions of a fuel cell separator when manufacturing the separator by compression molding, the separators can be inexpensively mass produced. Moreover, this method of the invention can be used to manufacture even separators having a complex channel geometry to a uniform density, uniform pore characteristics and a good precision.

Japanese Patent Application No. 2002-233800 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. method of manufacturing fuel cell separators, comprising the steps of:
(a) charging a powdered molding material into a compression mold, and
(b) compression molding the powdered material at a pressure of 0.98 to 49 MPa;
wherein the powdered material is charged in varying amounts for respective predetermined regions of the fuel cell separator.

2. method of manufacturing fuel cell separators, comprising the steps of:
(a) inserting a prefabricated preform into a compression mold,
(b) charging a powdered molding material onto the inserted preform, and
(c) compression molding the preform and the powdered material at a pressure of 0.98 to 49 MPa;
wherein the powdered material is charged in varying amounts for respective predetermined regions of the fuel cell separator.

3. The method of claim 1, wherein the predetermined regions are areas of differing volume on the fuel cell separator.

4. The method of claim 1, wherein the fuel cell separator has recessed areas and raised areas, and the predetermined regions are said recessed areas and raised areas.

5. The method of claim 1, wherein the fuel cell separator has a density variation of less than 5%.

6. The method of claim 1, wherein the fuel cell separator is porous.

7. The method of claim 6, wherein the fuel cell separator has a porosity of 1 to 50%.

8. The method of claim 6, wherein the pressure is 0.98 to 14.7 MPa.

9. A fuel cell separator obtained by the fuel cell manufacturing method of claim 1.
